(19) United States
(12) Patent Application Publication
(10) Pub. No.: US 2008/0134274 A1
(43) Pub. Date: Jun. 5, 2008

(54) Configuration Management for Co-Located Network Systems

(76) Inventors: Mike Arthur Derrenberger, Valencia, CA (US); Philippe Leyendecker, Chateaugiron (FR)

Correspondence Address: Joseph J. Laks;Thomson Licensing LLC, 2 Independence Way, Patent Operations, PO Box 5312, PRINCETON, NJ, 08543, US

(21) Appl. No.: 11/661,335

(22) PCT Filed: Aug. 26, 2005
(86) PCT No.: PCT/US05/30499

§ 371 Date: Feb. 27, 2007

Related U.S. Application Data
(60) Provisional application No. 60/605,907, filed on Aug. 31, 2004.

(51) Int. Cl. H04N 7/173

(52) U.S. Cl. 725/131

(57) ABSTRACT

One receiver is configured in the main state and the other receivers are configured in the secondary state. The receivers are communicatively coupled to each other via a local communications link and the main receiver determines the co-location state of the secondary states, and transmits authorization information to the secondary receivers in response to the determination. The secondary receivers are enabled to process program signals and provide output signals in response to the authorization information.

### CROSS-REFERENCE TO RELATED APPLICATIONS

This application claims the benefit of and/or priority to U.S. provisional patent application Ser. No. 60/605,907 filed Aug. 31, 2004, entitled, “Configuration Management for Co-Located Network System.”

### FIELD OF THE INVENTION

The invention relates generally to video distribution systems, and more particularly, to video distribution systems including co-located set-top boxes.

### BACKGROUND OF THE INVENTION

In the past, locations such as homes typically had at most one content receiver, often in the form of a set top box (STB). A location having multiple STBs was considered rare. Today however, more and more households contain two or more STBs that receive and share the same content distribution service, such as a digital broadcast satellite (DBS) television service. Thus, a typical consumer may now have more than one content receiver and interface, such as a STB and television. Content service providers, including DBS service providers may offer subscriptions that cover multiple satellite receivers or STBs (typically one for each television) on a single account. The primary STB is billed at a full service rate; however, subsequent STBs are billed at a lower rate. The cost savings to the consumer provides an incentive for obtaining such network service at multiple locations within the household, in comparison to separately activating the multiple STBs at full service rate for each location.

However, each of the multiple STBs is typically activated without regard to any of the other co-located devices. This unfortunately permits an STB to be moved to another location outside of the original video distribution system. A problem arises when a subscriber gives, sells, rents or otherwise provides the lower billed STB to another. In this manner non-subscribers may receive access to subscriber-based content services. This presents a theft of service problem regarding such video distribution systems. A mechanism for controlling operation of co-located set top box devices associated with a common account, while managing network, installation and user control of these devices among different modes and usage configurations, is desired.

### SUMMARY OF THE INVENTION

The present invention provides a method for managing a plurality of video processing units, or STBs, associated with a common subscriber account, which overcomes the problems mentioned above. In particular, the method according to the invention provides an arrangement wherein a selected video processing unit is configured to operate as the main unit and the other processing units are configured to operate as secondary units. The units are communicatively coupled together via a local communications link, whereby the main unit periodically determines the co-location status of the secondary units and provides authorization information to those units for which co-location status is confirmed. The secondary units receive and process the program signals from the service provider in response to receiving the authorization information. The management method includes placing the units into one of neutral, main, secondary, and non-operative states in response to configuration information from an installer, a user, or the service provider.

In particular, the invention provides a method for controlling a video processing unit adapted to receive and process program signals from a service provider, comprising the steps of: establishing a communicative coupling with a second video processing unit, which is associated with a common subscriber account, via a local communications link; and operating in one of first and second modes in response to received configuration information, wherein in the first mode the video processing unit periodically determines a co-location status with the second video processing unit and transmits authorization information via the local communications link to the second video processing unit in response to confirming the co-location status, and in the second mode processes the program signals to provide a display signal only upon receipt of authorization information via the local communications link. The invention also provides a video processing unit for implementing the method, and a method for managing a plurality of video processing units associated with a common subscriber account.

### BRIEF DESCRIPTION OF THE DRAWINGS

Understanding of the present invention will be facilitated by consideration of the following detailed description of the preferred embodiments of the present invention taken in conjunction with the accompanying drawings, wherein like numerals refer to like parts, and:

FIGS. 1a-1c depict block diagrams of exemplary video distribution system configurations;

FIG. 2 depicts a more detailed block diagram of a portion of the configuration of FIG. 1a;

FIGS. 3a-3e depict state diagrams for STBs according to aspects of the present invention;

FIGS. 4-9 depict graphical representations of graphical user interfaces according to aspects of the present invention;

FIG. 10 depicts a flow-diagram of a method according to an aspect of the present invention;

FIG. 11 depicts a block diagram of a bridge according to an aspect of the present invention; and,

FIGS. 12 and 13 illustrate block diagrams of a frequency spectrum of a video distribution system according to aspects of the present invention.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for purposes of clarity, many other elements found in typical content distribution systems and methods. Those of ordinary skill in the art will recognize that other elements are desirable and/or required in order to implement the present invention. However, because such elements are well known in the art, and because they do not facilitate a better understanding of the present invention, a discussion of such elements is not provided herein. Further, the embodiments disclosed herein are not intended to be exhaustive or limit the invention to the precise form disclosed so that others skilled in the art may utilize its teaching.

According to an aspect of the present invention, a method and system for connecting multiple set top boxes (STBs) to receive service provider signaling at a common location is provided. The method and system facilitates restricting operation of one or more of the STBs when they are not co-located. According to an aspect of the present invention, co-location authentication may be used to confirm physical proximity of associated STBs, such associated STBs including those STBs associated with a common service provider user account, for example. As will be understood, such authentication may be used to frustrate efforts to improperly obtain service revenue by “sub-leasing” or otherwise providing a STB for use, i.e., other than at a common location.

According to an aspect of the present invention, the STBs may be configured in main or secondary states, or modes. A main state configured STB may be used to provide real-time validation that secondary STBs are geographically co-located with the main state configured STB. Secondary state configured STBs may operate dependently upon main state configured STB provided messages. In particular, each STB may be selectively operated in one of a plurality of states, including as an autonomous device, a main device or a main-dependent (i.e., secondary) device. According to another aspect of the present invention, should a co-location requirement not be met, or cease to be met, at least some of the functionality of at least one of the STBs may be restricted. Co-location refers to the fact that multiple STB that are associated with a common subscriber account are actually located within the physical location and boundaries associated with the subscriber. Generally, that physical location is associated with a specific address, or building, but may also be associated with a plurality of addresses or building locations as required. Co-location may be determined by requiring the secondary STBs to respond to requests from the main STBs through a local communications link associated with the physical location. The link may be via wired or wireless media. The operation of the STBs may be restricted, for example, by disabling processing of the received program signals. Operational restricting is accomplished by transitioning one or more non-co-located STBs to a restricted state.

The system and method of the present invention may not require an additional communication link, e.g., wire, to be run between the STBs, although such a link may of course be used. Further, the system and method of the present invention provides a relatively easy set-up process and does not interfere with normal content delivery system signaling. Moreover, authentication and/or encryption of messages passed between STBs may be used to frustrate unauthorized use and/or tampering with one or more of the STBs.

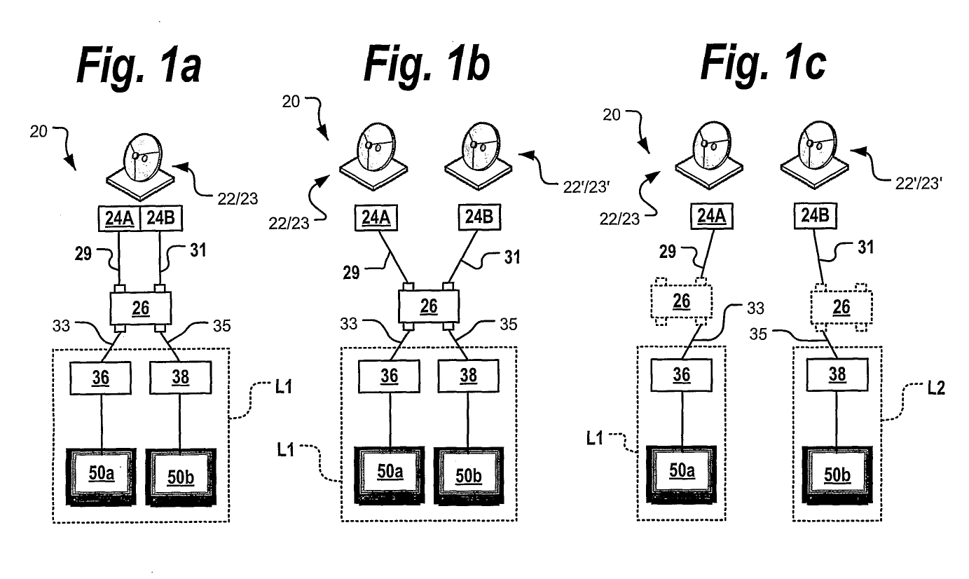

Referring now to the figures, wherein like references refer to like elements, FIGS. 1a-1c depict three exemplary configurations of content distribution system 20. Content distribution system 20 may take the form of an audio and/or video content distribution system, by way of non-limiting example only. System 20 may take the form of a data distribution system, for example. For purposes of explanation, the present invention will be further described as it relates to a video distribution system (VDS) 20, and in particular, to a satellite television type VDS such as a DBS system. It should be appreciated, however, that the present invention is not limited to such systems, but rather contemplates use within various other network systems and with other signal sources, such as wired and wireless source systems. Each VDS 20 generally includes one or more antennae 22, signal transducers 23, low-noise block down converters (LNBs) 24a, 24b, communications links 29, 31, 33, 35 (e.g., coaxial cables), bridge(s) 26, STBs 36, 38 and display devices 50a, 50b. STBs 36, 38 may be considered to be associated where they have been, or are to be, activated under at least one common account, e.g., a DBS subscription that calls for their co-location.

Referring first to FIG. 1a, STBs 36, 38 are co-located at a location L1. Location L1 may take the form of a service provider defined acceptable region or area within which both STBs 36, 38 are to be located. Location L1 may be geographically bounded, for example. Location L1 may be bounded by the signaling constraints of LNBs 24A, 24B, bridge 26, STBs 36, 38, displays 50a, 50b, or the communications links (e.g., coaxial cable) there between, for example. Location L1 may take the form of a single-family house, apartment, condominium, town-house or mobile-home, all by way of non-limiting example only. Further, location L1 need not be residential in nature. STBs 36, 38 may be considered to be properly co-located when they are within common location L1. When so co-located, the operation of STBs 36, 38 should not be restricted by the present invention. However, it should be understood that one or more conventional conditional access (CA) system(s) may be used to restrict operation of one or more of the STBs 36, 38 in a conventional manner.

The configuration of FIG. 1b largely corresponds to the configuration of FIG. 1a. However, in FIG. 1b separate antennae and signal transducers 22, 23 and 22′, 23′ are present, along with separate LNBs 24a, 24b. When STBs 36, 38 are co-located within location L1, the operation of STBs 36, 38 should not be restricted by the present invention. However, it should again be understood that one or more conventional conditional access (CA) system(s) may also be used to restrict operation of one or more of the STBs 36, 38 in a conventional manner.

The configuration of FIG. 1c largely corresponds to the configuration of FIG. 1b. However, STBs 36, 38 of FIG. 1c are not co-located. Rather, STB 36 is at a location L1, while STB 38 is at a location L2 distinct from location L1. In such a case, one or more bridges 26 may or may not be present. Either way, the operation of one or more of STBs 36, 38 should be restricted by the present invention. However, it should again be understood that one or more conventional conditional access (CA) system(s) may also be used to restrict operation of one or more of the STBs 36, 38 in a conventional manner.

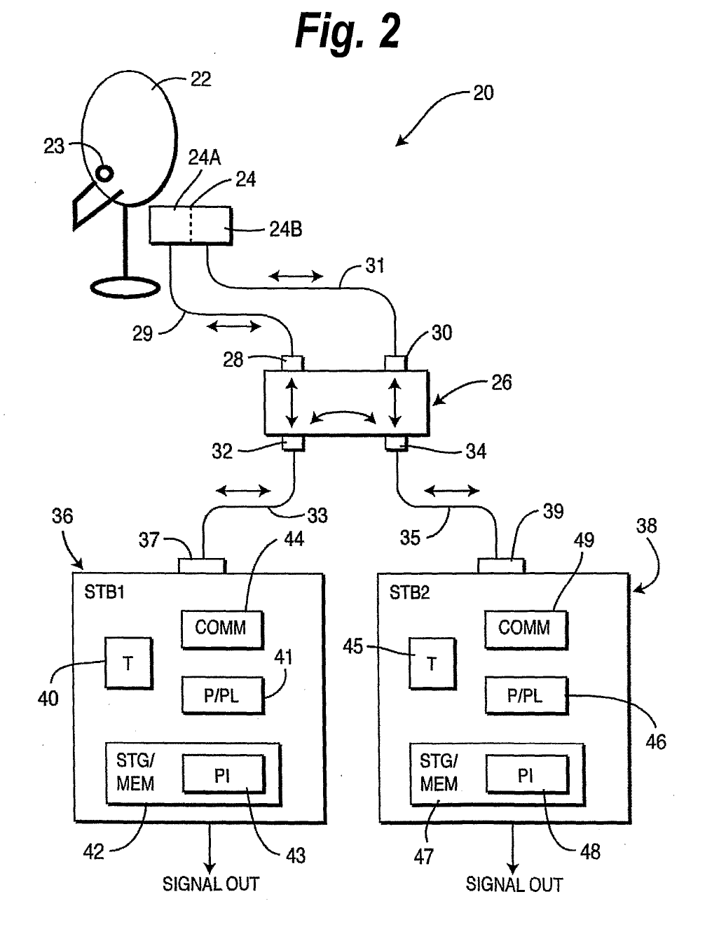

Referring now also to FIG. 2, there is shown a block diagram of a video distribution system (VDS) 20 according to an aspect of the present invention. While VDS 20 of FIG. 2 is of a particular configuration, it should be appreciated that VDS 20 represents the numerous types of systems and/or configurations thereof that can utilize the present principles. Also, it should be appreciated that FIG. 2, like the other figures hereof, is representational only and as such is neither to scale nor necessarily to scale relative to its own components.

VDS 20 includes antenna or signal receiver 22 that is configured, adapted and/or operable to receive video signals (e.g. television signals) from a satellite (not shown). It should be appreciated that antenna 22 represents the numerous types of antennas or signal receivers (e.g. a headend) that may be used in a VDS along with the present invention, the type of which is generally determined by the source of the signal. As such, the signal source may be other than a satellite. Antenna 22 is shown with a signal transducer (e.g., feed horn) 23 that receives transmitted or broadcast video signals and transmits the received video signals to a dual or twin Low Noise Block down-converter (LNB) 24.

LNB 24 includes first and second LNBs 24A and 24B (or LNB A and LNB B). Each LNB 24A and 24B is configured, adapted and/or operable such as is known in the art to down-convert the received video signals. LNB 24 may optionally amplify and/or otherwise condition the received signals. While two LNBs are shown, it should be appreciated that LNB 24 may consist of any number of LNBs. Moreover, it should be appreciated that LNB 24 represents other types of signal reception/conditioning devices that may be used in a VDS.

LNB 24 is also a controllable device that receives commands and provides data and/or implements received command(s), as appropriate. As such, LNB 24 utilizes a communication protocol to effect such functionality. One communication protocol commonly used is the Digital Satellite Equipment Control (DiSEqC) protocol, but other communication protocols may be utilized. It should be appreciated that the LNBs 24 also represent various types of controllable video distribution devices, video reception devices or video distribution system accessories, such as multi-switches, amplifiers and/or the like.

A DiSEqC system is a communication bus particularly used between satellite receivers and satellite peripheral equipment (e.g. multi-switches, LNBs), using coaxial cable as the network media. DiSEqC can be integrated into consumer satellite installations and replace conventional analog (voltage, tone or pulse width) switching and other control wiring between devices. DiSEqC, as defined by Eutelsat, is a single master, single or multiple slave system. The DiSEqC protocol was designed for applications where there is one bus “master” and all other DiSEqC-compatible devices in the system are considered DiSEqC “slaves”. With the DiSEqC protocol, only a DiSEqC master device may initiate communication. A DiSEqC slave will reply, if defined by a DiSEqC command it received, to the DiSEqC master, but the DiSEqC slave cannot initiate communications. Thus, communications can be initiated only by the DiSEqC master device. The DiSEqC master device is typically an integrated receiver device (RD); also known as a set-top box (STB). A traditional DiSEqC system cannot support multiple STBs because each STB would be considered a DiSEqC “master”. Currently, because of such constraints, each STB is often wired as a separate DiSEqC system to its associated LNB. DiSEqC communication between STBs is thus not conventionally possible because each STB would want to act as a DiSEqC master. (see DiSEqC Bus Functional Specification”, version 4.2, European Telecommunications Satellite Organization, Feb. 25, 1998). As will be understood by those possessing an ordinary skill in the art, though not critical, the principles hereof may be used with a DiSEqC system. Thus, the present invention has equal applicability to non-DiSEqC VDS implementations.

Referring again to FIG. 2, the illustrated VDS 20 includes two set-top boxes (STB1)36 and (STB2)38. In the illustrated embodiment STBs 36,38 take the form of satellite television receivers, but other types of STBs, receivers and/or the like may be used. Further, while only two receivers are shown, a VDS in accordance with and/or incorporating the principles of the present invention, may have more than two STBs. STBs 36 and 38 are configured, adapted and/or operable as satellite receivers and thus include the typical functionality as known in the art for satellite receivers. Therefore, each STB 36 and 38 includes components and logic such as is known in the art for providing typical operation of an STB or satellite receiver, as well as for the implementation of the present invention. While not a complete depiction and/or description of each component or function of the STB, each STB 36 and 38 is shown as having a tuner 40 or 45, a processor 41, 46, memory 42, 47, program instructions 43, 48 for carrying out the functions of the STB and the present invention and communications devices 44, 49. “Processor”, as used in herein, refers generally to a computing device including a Central Processing Unit (CPU), such as a microprocessor. A CPU generally includes an arithmetic logic unit (ALU), which performs arithmetic and logical operations, and a control unit, which extracts instructions (e.g., code) from memory and decodes and executes them, calling on the ALU when necessary. Other examples of processors include digital signal processors, and other devices having processing logic, such as controllers, like microcontrollers. “Memory”, as used herein, generally refers to one or more devices capable of storing data, such as in the form of chips, tapes or disks. Memory may take the form of one or more random-access memory (RAM), read-only memory (ROM), programmable read-only memory (PROM), erasable programmable read-only memory (EPROM), or electrically erasable programmable read-only memory (EEPROM) chips, by way of further non-limiting example only. The memory utilized may be internal or external to an integrated unit including a processor. Each component is operable, configured and/or adapted to perform in a manner typical thereof and in a manner that implements the present invention.

According to the principles of the present invention, VDS 20 includes a connection, coupling, communication and/or VDS component pairing (pairing) device 26 also known as (and collectively) a bridge. The bridge 26 includes first and second input/output ports 28, 30 and first and second input/output ports 32, 34. Input/output port 28 is connected via coaxial cable (coax) or other communication link 29 to one (LNB A or 24A) of the twin LNB 24. Input/output port 30 is connected via coaxial cable (coax) or other communication link 31 to the other LNB (LNB B or 24B) of the twin LNB 24. Input/output port 32 of the bridge 26 is connected via coaxial cable (coax) or other communication link 33 to an input/output port 37 of STB 36. Input/output port 34 of the bridge 26 is connected via coaxial cable (coax) or other communication link 35 to an input/output port 39 of STB 38. The bridge 26 is thus interposed between the twin LNB 24 and the STBs 36 and 38. The STBs 36 and 38 are in communication with the twin LNB 24 via the bridge 26. As represented by the various arrows associated with VDS 20, bridge 26 allows communication between STBs 36 and 38 (inter-STB communication or two-way communication) and communication between an STB 36, 38 and one of the LNBs of the twin LNB 24 (one-to-one or one-way communication with a LNB).

Signal output ports of the STBs 36, 38 may be coupled to input ports of display devices 50a, 50b (FIGS. 1a-1c). In the case of a VDS, display devices 50a, 50b may take the form of analog or digital televisions, for example. Corresponding analog or digital links may be used to provide connectivity between STBs 36, 38 and displays 50a, 50b, respectively. Alternatively, STBs 36, 38 may be integrated with displays 50a, 50b, or removably insert-able therein, analogously to a smart-card/digital television configuration for example. In such a case, the integrated STB 36, 38 and display 50a, 50b would provide the combined functionality of separate STBs 36, 38 and displays 50a, 50b.

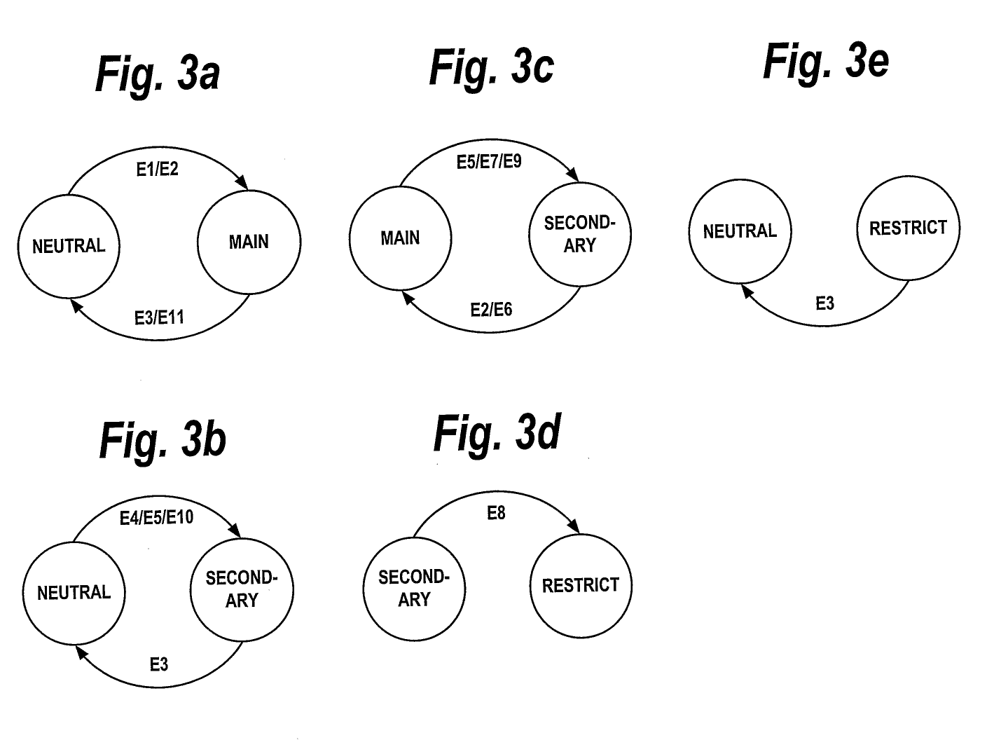

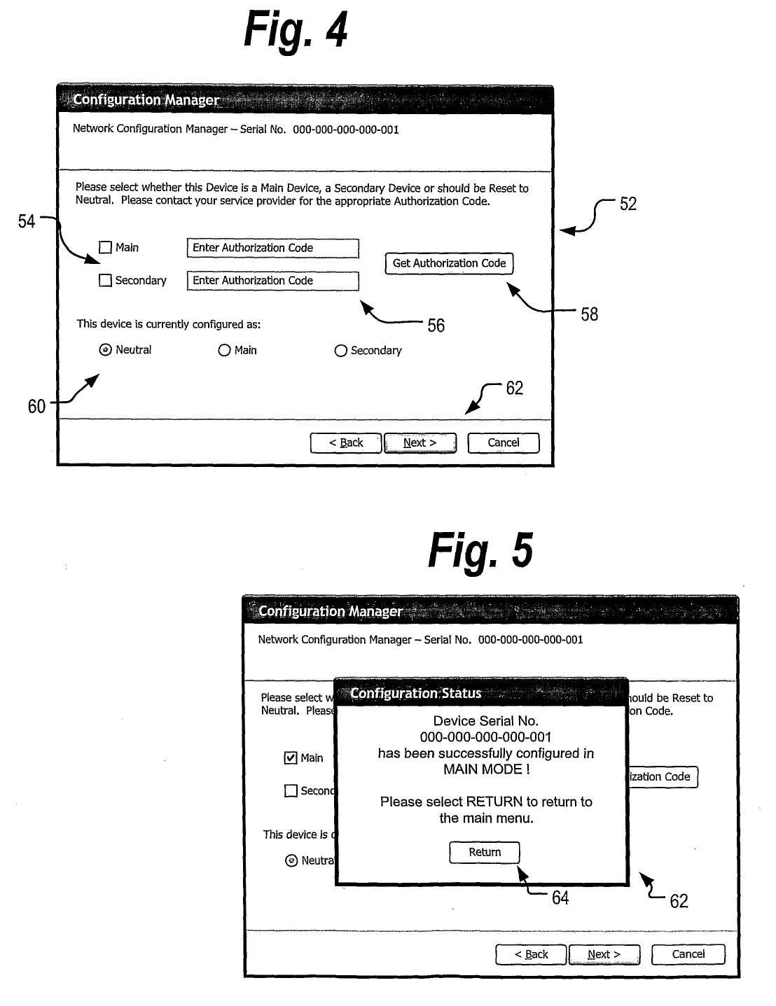

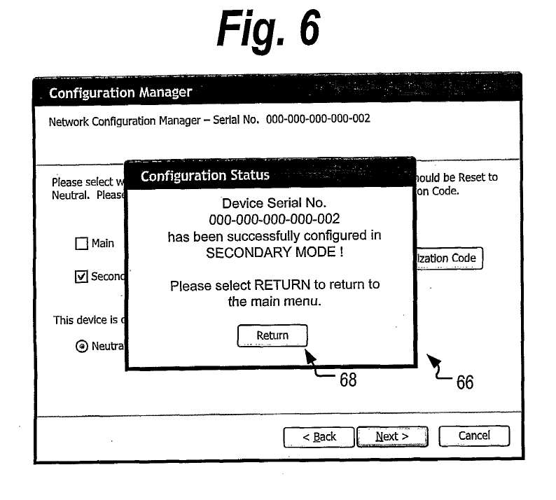

Referring now also to FIGS. 3a-3e, according to an aspect of the present invention, each of the STBs 36, 38 may be operated in a plurality of states. Each of the STBs 36, 38 may be operated in: (1) a neutral state, (2) a main state, (3) a secondary state or (4) a restricted state. Other states, and numbers of states, are also contemplated. In the main and secondary states, the STB 36, 38 is functionally operable in terms of user interaction and operation of the device to enable subscriber selection and access to content from the service provider in conventional fashion. In the neutral and restricted states, however, user interaction and operation of STB 36, 38 may be restricted such that the device is not functionally operable to enable subscriber selection and access to content from the service provider.

According to an aspect of the present invention, each STB 36, 38 may be initially configured in a neutral state. When in the neutral state, the STB may not operate to receive and display content, irrespective of conditional access (CA) permissions. Prior to operation, e.g., prior to use of the STB 36, 38 to provide content to a display 50a, 50b (FIGS. 1a-1c), the STB is transitioned to either the main state or the secondary state. As shown in FIG. 3a, upon an authorized command issued to the STB by a VDS user or installer to configure the device in a main operational state (event EI), the STB 36, 38 transitions from the neutral state to the main state. As also shown in FIG. 3a, upon an authorized command by a service provider to STB 36, 38 to configure the device in a main operational state (event E2), the STB transitions from the neutral state to the main state. As shown in FIG. 3b, upon an authorized command issued by a VDS user or installer to configure the device in a secondary operational state (event E4), the STB 36, 38 transitions from the neutral state to the secondary state. As is also shown in FIG. 3b, upon an authorized command issued by a service provider to configure the device in a secondary operational state (event E5), the STB 36, 38 transitions from the neutral state to the secondary state. As is also shown in FIG. 3b, upon an automatic discovery and configuration (event E10), STB 36, 38 transitions from the neutral to the secondary state.

As is also shown in FIGS. 3a and 3b, upon an authorized command by a service provider to configure the device in a neutral state (event E3), STB 36, 38 transitions from the main state or the secondary state to the neutral state. Further, where multiple STBs 36, 38 are configured in the main state, they may, after some period of time, be transitioned to the neutral state (event E11).

According to an aspect of the present invention, each STB 36, 38 may transition between the main and secondary states. As is shown in FIG. 3c, upon an authorized command by a service provider to configure the device in the secondary state (event E5), a STB 36, 38 transitions from the main state to the secondary state. As is also shown in FIG. 3c, upon an authorized command by a VDS user or installer to a STB 36, 38 to re-configure the device from the main state to the secondary state (event E7), a STB 36, 38 transitions from the main state to the secondary state. As is also shown in FIG. 3c, in the event a new main state configured STB 36, 38 is defined (event E9), another STB 36, 38 may transition from the main state to the secondary state. Again, and as is also shown in FIG. 3c, upon an authorized command by a service provide to a STB to configure the device in the main state (event E2), a STB 36, 38 transitions from the secondary state to the main state. And, as is shown in FIG. 3c, upon an authorized command by a VDS user or installer to a STB 36, 38 to configure the device in the main state from the secondary state (event E6), a STB 36, 38 may transition from the secondary state to the main state.

According to an aspect of the present invention, each STB 36, 38 may selectively transition from the secondary state to a restricted state. As is shown in FIG. 3d, in the event a STB 36, 38 does not have authorization to operate, e.g., possesses a valid token as is explained herein below (event E8), that STB 36, 38 may transition from the secondary state to the restricted state. The transition from the secondary state to the restricted state automatically occurs without input from an installer, customer or service provider.

According to an aspect of the present invention, each STB 36, 38 may transition from the restricted state to the neutral state. Upon an authorized command by a service provider to a restricted state configured STB 36, 38 to configure the device in the neutral state (event E3), that STB 36, 38 transitions from the restricted state to the neutral state, as shown in FIG. 3e. In one embodiment, a STB can only be transitioned from the restricted state to the neutral state in response to a command transmitted by the service provider.

Service provider driven events, e.g., event E2, may be triggered upon a service provider transmitting a command, such as a predetermined message or data string, to a target STB 36, 38, e.g., via antenna 22. Identification data uniquely identifying the corresponding STB, such as the serial number of the target STB, may be used for addressing the broadcast command, for example. According to an aspect of the present invention, VDS user or installer driven events, e.g., event E1, may be triggered by user commands received via a graphical user interface (GUI) presented to the user or installer utilizing STB 36, 38 and display 50a, 50b in a conventional manner.

For example, a STB may be initially configured in the neutral state. Upon activation, or attempted initialization, configuration or setup, the device may be induced to transition to the main state, responsively to event E1 or E2 (FIG. 3a). In one configuration, when a user establishes a user account with a service provider, the service provider may broadcast an event E2 inducing message across the communications network and addressed to, or referring to, the STB 36, 38 having the serial number associated with the main state configured STB for that account, e.g., STB 36. The service provider may also broadcast an event E5 inducing message across the communications networks and addressed to, or referring to, the STB 36, 38 having the serial number associated with a secondary state configured STB for that account, e.g., STB 38. All other STBs in communication with the service provider may ignore these broadcast messages as not being directed to them. Likewise, event E1 or E5 may result from user or installer interaction with STB 36, 38.

Referring now also to FIG. 4, there is shown a graphical depiction of an exemplary GUI 52 that may be presented to a user or installer on display 50a, 50b by STB 36, 38. A user or installer may interact with GUI 52 using a conventional STB 36, 38 remote control or other input device. GUI 52 is well suited for triggering events E1, E4, E6 and E7, for example. GUI 52 may be presented to a user or installer responsively to user interaction with a STB 36, 38 menu system. GUI 52 includes data items suitable for use by a user of the associated STB 36, 38. In general, the use of data items, e.g., selection boxes, radio buttons, text boxes and buttons, are well known to those possessing an ordinary skill in the GUI technical arts.

The illustrated GUI 52 includes data items 54 for allowing a user to select whether to transition the STB 36, 38 to the main state or the secondary state. GUI 52 includes data items 56 for permitting a user or installer to manually enter an authorization code to authorize the transition selected using data items 54. By way of example, the authorization code may be dependent upon the STB 36, 38 serial number and date or time after which the authorization code will be invalid. In this way, the authorization code may be unique for a given STB 36, 38 and expires after some temporal period, to avoid impermissible authorization code re-use. The authorization code may take the form of a hash, for example. A “hash” is a value generated from a string of text. The hash is substantially smaller than the text itself, and is generated by a formula in such a way that it is statistically unlikely that other text will produce the same hash value. The serial number and/or date/time and/or requested state transition may be used to generate the hash.

In one configuration, an authorization code is manually acquired from an authorizing service provider by the user or installer providing the STB 36, 38 serial number and/or account information to the service provider, and the service provider communicating the authorization code back to the user or installer. In another configuration, an authorization code is automatically acquired by a STB 36, 38. GUI 52 further includes data item 58. Upon activation of a data item 58, STB 36, 38 may enter into a communications session with an authorizing service provider using an internal communications apparatus, such as a conventional public switched telephone network (PSTN) operable modulator/demodulator (MODEM). Of course, other communications paths to a service provider from a STB may also be used. Upon contacting the service provider, the STB 36, 38 may transmit the serial number and request an authorization code for the state transition the user or installer selected through data items 54. By querying a database that relates serial numbers, account information and current STB states, an authorization code is provided to the requesting STB 36, 38 by the service provider where permissible. The current date and time is acquired by a STB 36, 38 from the service provider, via antenna 22, for example, and used to validate the authorization code.

GUI 52 further includes data items 60, for indicating the current state of the STB 36, 38. GUI 52 also includes data items 62, for providing navigation throughout a menu structure GUI 52 presented within. The use of such navigational aids and menu structures are well known by those possessing an ordinary skill in the GUI technical art.

Upon attempted authorization, by a user selecting a “Next” one of the data items 62, an authorization process is performed to check the validity of the authorization code. For example, the STB 36, 38 may independently calculate a hash and compare it to the authorization code hash. If the authorization code is validated by this comparison, the state transition reflected by data items 54 may be effected. Another GUI indicative of the outcome of the comparison is then presented to the user or installer.

Referring now also to FIG. 5, there is shown a graphical representation of a GUI 62 superimposed over GUI 52 of FIG. 4. The illustrated GUIs 52, 62 are representative of the associated STB 36 being successfully transitioned to the main state from the neutral state by a user or installer of the associated VDS (event E1). GUI 62 may also include data items. In the illustrated case, GUI 62 includes a data item 64 for enabling a user or installer to return to a main menu. Referring now also to FIG. 6, there is shown a graphical representation of a GUI 66 superimposed over GUI 52 of FIG. 4. The illustrated GUIs 52, 66 are representative of the associated STB 38 being successfully transitioned to the secondary state from the neutral state by a user or installer of the associated VDS (event E4). Like GUI 62, GUI 66 may also include data items. In the illustrated case, GUI 66 includes a data item 68 for enabling a user or installer to return to a main menu.

According to an aspect of the present invention, two or more STBs 36, 38 may be associated with one another and a given account. This association may be reflected in the service provider's records, such as in a data base accessible to the service provider. In one configuration, the associated STBs 36, 38 are authorized for use at a common location (e.g., L1, FIGS. 1a and 1b). According to an aspect of the present invention, only a single one of the associated STBs 36, 38 may be configured in the main state. Accordingly, an authorization code may be withheld and reconfiguration denied where a user or installer attempts to configure a second one of the associated STBs 36, 38 in the main state. Alternatively, a broadcast message to force the previously main state configured associated STB 36, 38 into the neutral state or the secondary state may be effected (e.g., to trigger event E5). Also, a STB configured in the main state may be automatically transitioned to a restrict state if the STB is unable to establish communication with all of the secondary STBs.

When a STB is successfully transitioned to the main state, the STB may broadcast a message to all other STBs operationally coupled to a common VDS. This message may include information associated with its system configuration (e.g. indicate that the STB is operationally coupled to the VDS), its operational mode (e.g. configured in the main state), and its connectivity (e.g. indicate whether it is connected to a separate communications link, e.g., a PSTN). The message may further include information that indicates the secondary state configured STBs registered with the device, and provide its serial number and/or network address. A main state configured STB may periodically re-broadcast this message. When a STB is operationally coupled to a VDS, the STB can monitor the VDS for the main state configured STB broadcast transmissions. Where a neutral state configured STB receives the main state configured STB broadcast message (event E10), it may transition to the secondary state (FIG. 3b), and respond by providing its serial number and/or network address to the main state configured STB. Upon receipt of a first such broadcast message, each secondary state configured STB responds by providing its serial number and/or network address to the main state configured STB. Upon receipt of each response, the main state configured STB can register the device by storing its serial number and/or network address in memory, and including the stored serial number and/or network address in future broadcast messages. Upon receiving additional broadcast messages from the main state configured STB, a secondary state configured STB can confirm it is registered with the broadcast transmitting main state configured STB, and periodically respond to maintain the main state configured STB registry current. Conventional data collision avoidance techniques may be used.

In the event that a main state configured STB receives a broadcast transmission from another main state configured STB, it may trigger event E9 or E11, whereby the receiving main state configured STB is transitioned to the secondary state (FIG. 3c) or the neutral state (FIG. 3a). Alternatively, multiple (i.e., two or more) such broadcast transmissions may be received and logged in memory before an event E9 or E11 is triggered. Optionally, the broadcast message receiving, main state configured STB can transmit a message to the broadcast message transmitting, main state configured STB, causing it to experience an event E9 or E11. Again, multiple such transmissions may be received and logged in memory before an event E9 or E11 is triggered thereat.

For purposes of further explanation, it will be assumed that STB 36 (STB1, serial no. 000-000-000-000-001) is configured in the main state (as is shown in FIG. 5), and STB 38 (STB 2, serial no. 000-000-000-000-002) is configured in the secondary state (as is shown in FIG. 6). In such a case, in the configuration of either FIG. 1a or 1b, STB 36 may authorize STB 38 to operate. However, in the case of the configuration of FIG. 1c, STB 38 may not be authorized by STB 36, as they are not co-located—resulting in STB 38 transitioning to the restricted state (event E8) and restricting its operation.

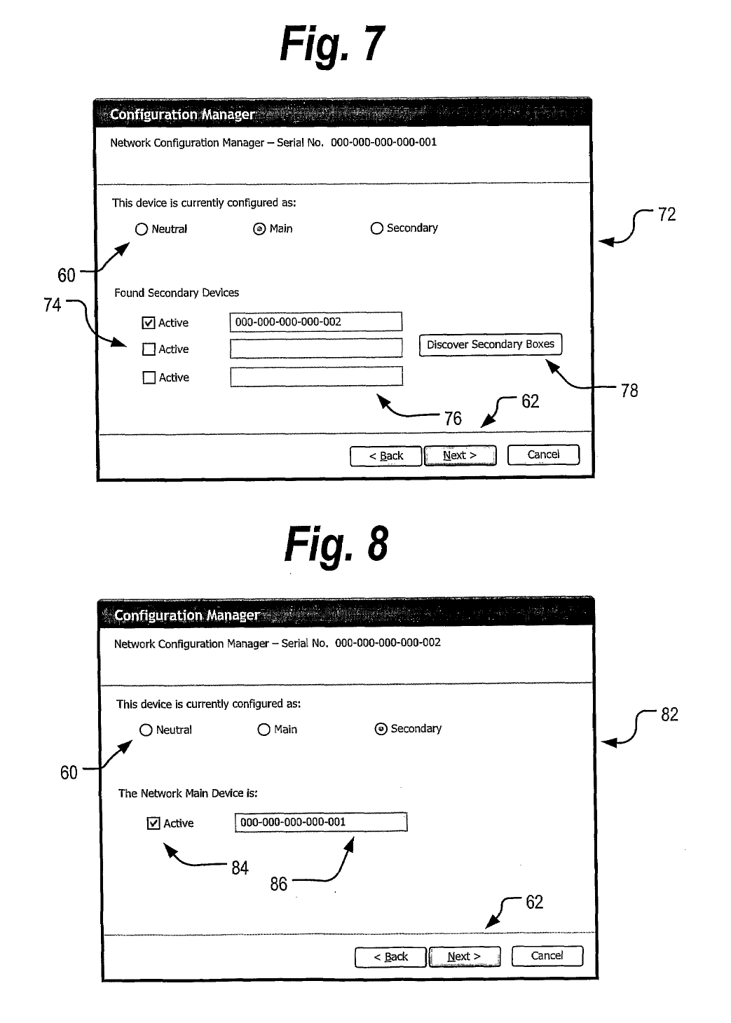

FIG. 7 is an exemplary illustration of a GUI 72 that shows the configuration of STB 36 as configured in the main state. This is provided by data item 60. GUI 72 also includes data items 74, 76. Data items 74, 76 identify those STBs configured in the secondary state and registered with STB 36 which, in the illustrated case, is STB 38. GUI 72 also includes data item 78. By selecting data item 78, a user or installer causes STB 36 to transmit a a broadcast message indicating that it is connected to the network and configured in the main state. By activating data item 78, a user or installer need not wait for the periodic re-transmission of this message to provide an opportunity to register the secondary state configured STB 38. Data items 74 may indicate whether a registered secondary state STB 38 is believed to be actively connected, e.g., whether it has communicated with the main state configured STB 36 within some threshold period, or is believed inactive because the threshold has expired since the last time the corresponding secondary state configured STB 38 has communicated with the main state configured STB 36. GUI 72 also includes data items 62 as previously discussed.

FIG. 8 is an exemplary illustration of a GUI 82. GUI 82 illustrates STB 38 is configured in the secondary state as provided by data item 60. GUI 82 also includes data items 84, 86. Data items 84, 86 identify STB 36 as being configured in the main state and that STB 38 is registered with it. Data item 84 may indicate whether the registering main state STB 36 is believed to be actively connected, e.g., whether it has communicated with the secondary state configured STB 38 within some threshold period, or believed inactive because the threshold has expired since the last time the corresponding main state configured STB 36 has communicated with the secondary state configured STB 38. GUI 82 also includes data items 62 as previously discussed.

As set forth above, and as illustrated in FIG. 3d, when a STB is in the secondary state, it may be transitioned to the restricted state (event E8). This transition from the secondary state to the restricted state may be based upon the secondary state configured STB being authorized by a main state configured STB (e.g., secondary state configured STB 38 having a current authorization from main state configured STB 36). In the event that the authorization ceases or is otherwise absent (event E8), the secondary state configured STB (e.g., STB 38) may be transitioned to the restricted state, and user operation of the STB is restricted. Transitioning to the restricted state overcomes the problem of multiple STBs associated with a common subscriber account being placed in different locations. In an embodiment according to the invention, the STB that is configured in the main state periodically determines the co-location status of the secondary STBs. The co-location status may be determined by, for example, requiring the secondary STBs to respond to a query from the main STB via a local communications link, for example, on a telephone line associated with the location, a cable line associated with the location, etc. The determination may also be performed on a wireless link, for example, by comparing signal levels from the initial signal levels to determine whether the STBs may have been moved outside a specified range. The main STB may periodically transmit the query to constantly monitor the co-location status. Based on the determination, the main STB transmits authorization information to the secondary STBs to enable the second STBs to continue to process the program signals and provide an output signal suitable for display. If the secondary STBs do not receive the authorization information, which may be required on a periodic basis, the second STBs automatically transition to the restricted state.

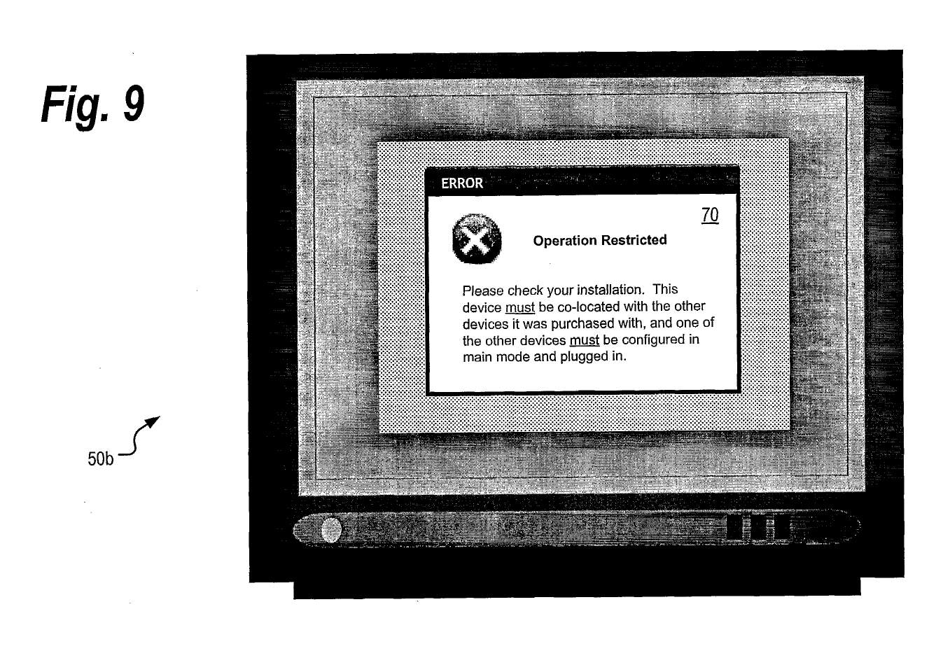

Referring now also to FIG. 9, there is shown a graphical representation of display 50b after the corresponding STB has transitioned to the restricted state. In the restricted state, the STB may not process and/or present content, e.g., display video and/or play audio, that an underlying CA system may otherwise permit. A restricted state configured STB (e.g., STB 38 in the configuration of FIG. 3c) may further present the user or installer with a GUI 70 that advises of the restriction. In order to un-restrict operation of STB 38, it may be transitioned to the neutral mode (FIG. 3e) responsively to event E3. To effect an event E3, a user or installer may contact the service provider and request the restricted STB be reset to neutral (by providing a serial number, and user account information, for example). Upon approval of the service provider, a reset command comprising a predefined message or data string addressed to the restricted state STB (e.g., STB 38, serial no. 000-000-000-000-002) may be broadcast by the service provider for receipt by the restricted state STB 38 (via antenna 22, for example) to effect event E3. After receipt of the broadcast message, and reset to neutral state has been effected, STB 38 may be transitioned to either the main or secondary state, as previously discussed.

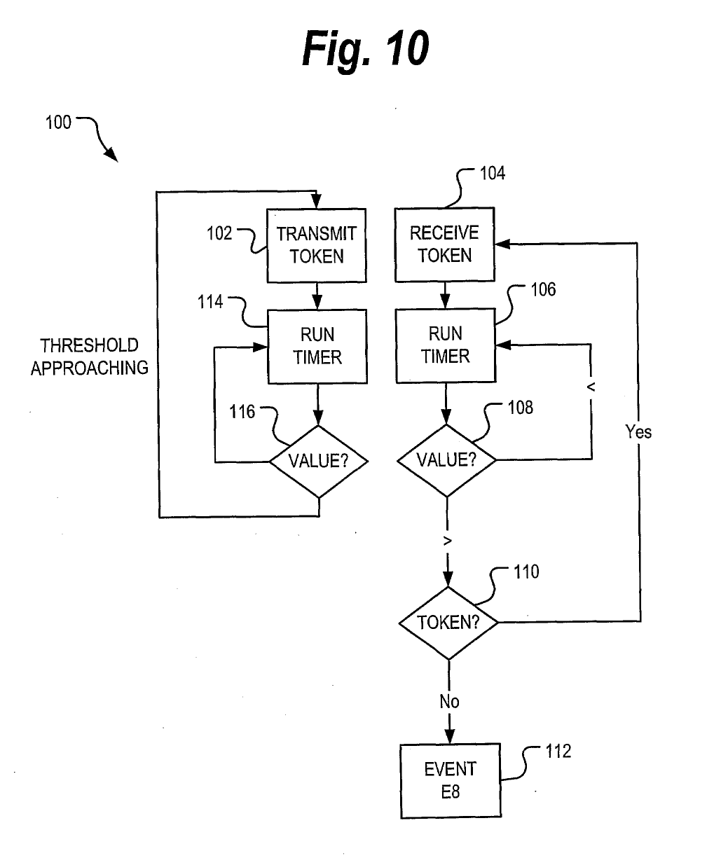

According to an aspect of the present invention, the system may utilize token processing for determining STB transitions between secondary and restricted state configurations. FIG. 10 shows a block diagram of a process 100 wherein a main state configured STB 36 transmits a token 102 to each secondary state configured STB registered with it (e.g., STB 38). Upon receiving and validating the token 104, STB 38 executes a timer or counter 106. This counter may be incremented or decremented. Upon reaching a predetermined threshold 108, (e.g. 15 minutes, 1 hour, 24 hours, etc.) the secondary state configured STB 38 may transition to the restricted state (event E8) 112 in the event another token has not been received 110. Main state configured STB 36 increments or decrements an analogous timer 114. In order to preclude the secondary state configured STB 38 from transitioning to the restricted state 112, STB 36 transmits another token 102 addressed to STB 38 prior to the threshold being reached 116.

Each STB 36, 38 may store several values in its memory 42, 47, with each value indicative of a unique identifier, or serial number, optionally in a secure location. Each STB 36, 38 may store a value indicative of its present state, optionally in a secure location. Each STB 36, 38, when configured in a main state, may store values indicative of other STBs 36, 38 that are configured in a secondary state and that are connected to a common VDS, e.g., bridge 26, optionally in a secure location. Each STB 36, 38 may store a value indicative of its identifier on a VDS to which it is connected, optionally in a secure location. When configured in a secondary state, each STB 36, 38 may store authorization values, such as values indicative of a conventional token being received, and timer values (e.g., current value, start value), optionally in a secure location. Each STB 36, 38 may store a value indicative of whether it is coupled to a communication line suitable for contacting a service provider (e.g., a PSTN phone line). Each STB 36, 38 may store values indicative of an allowable time limit, and amount of time, that multiple STBs 36, 38 configured in a main state may co-exist on the network. In the event of a violation, e.g., the time limit is exceeded by the timer (event E11); some or all such STBs 36, 38 may be transitioned to the neutral state. Such values may be stored as bits, or bytes, in one or more memory locations, for example.

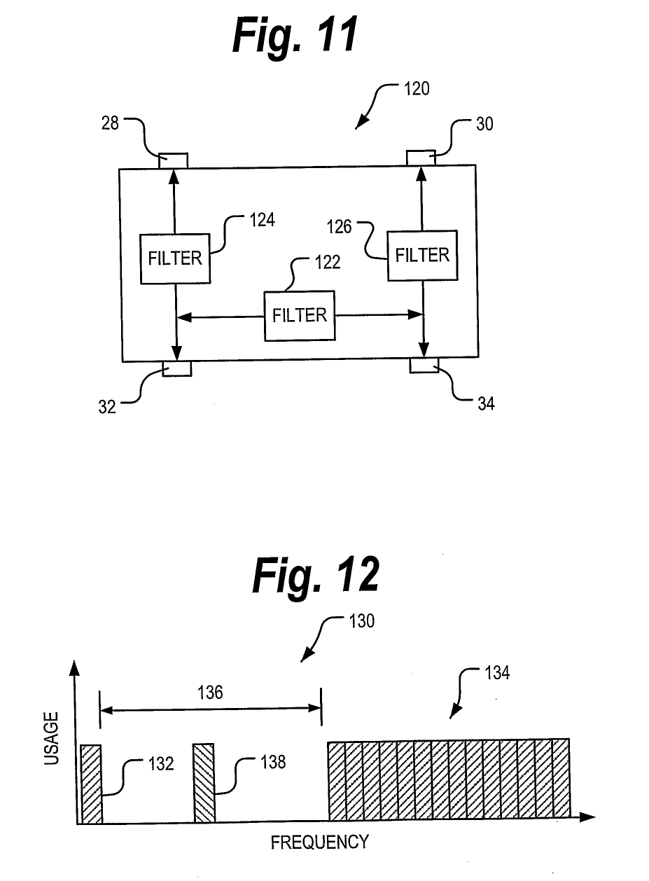

According to an aspect of the present invention, bridge 26 may facilitate communications between STBs 36, 38. Referring now to FIG. 11, there is shown a block diagram of a bridge 120 according to an aspect of the present invention. Bridge 120 of FIG. 11 may be used as bridge 26 of FIG. 2. Bridge 120 is configured, adapted and/or operable to pair an STB with an LNB. This is illustrated in FIGS. 2 and 11 by the vertical double-headed arrows within the bridge 26, 120 and situated between input port 30 and output port 34, and between input port 28 and output port 32. The bridge enables STB 36 to communicate with, query and control LNB 24A, and allows STB 38 to communicate with, query and control LNB 24B. Each STB 36, 38 is thus able to send commands to its respective LNB 24A, 24B while the twin LNB 24 is able to provide a reply to the corresponding STB 36, 38 through a data path in the bridge 26, 120. The reply may include or comprise data, a message, or otherwise. Bridge 26, 120 also allows inter-communication between STBs 36, 38 as represented by the double-headed arrow within the bridge and situated between output ports 32 and 34. Thus, each STB 36, 38 is able to send commands to any other STB 36, 38 via another data path.

Referring still to FIG. 11, bridge 120 includes filters 122, 124 126. Each filter 122, 124, 126 may take the form of multiple signal filters, or a filter set, as is conventionally understood in the arts. Filter 122 is interposed between input/output port 32 and input output port 34. Thus, in the configuration of FIG. 2, filter 122 is interposed between STB 36 and STB 38. Filter 124 is interposed between input/output port 32 and input/output port 28. Thus, in the configuration of FIG. 2, filter 124 is interposed between STB 36 and LNB 24A. Filter 126 is interposed between input/output port 34 and input/output port 30. In the configuration shown in FIG. 2, filter 126 is interposed between STB 38 and LNB 24B.

Referring now also to FIG. 12, there is shown a frequency spectrum 130 of a VDS according to an aspect of the present invention. Spectrum 130 includes bandwidth 132 being reserved for conventional VDS signaling, e.g., conventional DiSEqC signaling. Spectrum 130 also includes bandwidth 134 being reserved for conventional VDS signaling, e.g., transponder channels. Spectrum 130 further includes a bandwidth 136 unreserved for conventional VDS signaling. Bandwidth 136 may have a central frequency greater than a central frequency of bandwidth 132 and lower than a central frequency of each of the transponder channels 134. Alternatively, bandwidth 136 may have a central frequency lower than a central frequency of bandwidth 132. Alternatively, bandwidth 136 may have a central frequency greater than a central frequency of each of the transponder channels 134.

Referring now to FIGS. 11 and 12, filter 122 may be configured to pass a portion 138 of bandwidth 136, while rejecting other bandwidths, e.g., 132, 134. Consistently, STBs 36, 38 (FIG. 2) may be configured to communicate with one another using bandwidth 138. In such a case, STBs 36, 38 may pass messages, e.g., data patterns, to one another, such as tokens and/or other messages. Further, in such a configuration, filters 124, 126 may be configured to pass bandwidths 132, 134 between the respectively connected STBs 36, 38 and LNBs 24A, 24B, while rejecting at least a portion 138 of bandwidth 136. Alternatively, where LNBs 24A, 24B are configured not to receive or act upon signaling within portion 138 of bandwidth 136, filters 124, 126 may be omitted all together.

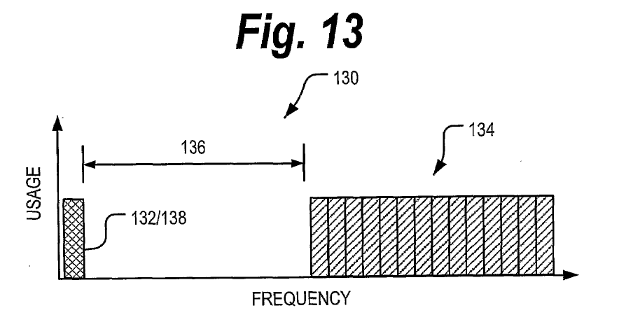

FIG. 13 illustrates a frequency spectrum analogous to that of FIG. 12, but wherein communications between STBs are integrated with conventional VDS signaling, e.g., integrated with conventional DiSEqC signaling. In such a case, bandwidth portion 138 coincides with at least a portion of bandwidth 132. In such a case, bridge 26 may include a processor. The bridge may also include a memory. The memory may store a computer program, e.g., sequence of instructions being operable by a processor. The memory may store mailboxes, buffers and/or the like for functional operation of the bridge 26 in the manner described in U.S. patent application Ser. No. 10/______, filed ______, 2004, and entitled “Supporting Multiple DiSEqC Set-Top Boxes”. Further, each STB may be communication protocol enabled, such as DiSEqC enabled and/or compatible. In such a case, each STB may also be configured, adapted and/or operable to utilize DiSEqC extensions or bus control commands to communicate with one another and with their respective accessory through the bridge 26. Particularly, through the use of vendor extensions, various commands in the form of a custom communication code may be provided as vendor extensions to DiSEqC. In such a case, bridge 26 may accept, read, store, forward, transmit and act upon the present pairing bridge extensions (as are the STBs). A more detailed discussion regarding such a configuration is discussed in the afore-incorporated U.S. patent application Ser. No. 10/______, filed ______, 2004, and entitled “Supporting Multiple DiSEqC Set-Top Boxes”, with regard to FIGS. 1-3, which discussion is specifically incorporated by reference herein.

Regardless of the particulars of bridge 26, according to an aspect of the present invention, where a STB 36, 38 is not itself provided with a back-channel communication path to a service provider, e.g., it is not itself coupled to a PSTN, it may transmit a message to one or more of the STBs 36, 38 querying whether any of them have such a connection available. In the event another STB does, it may respond in the affirmative to the querying STB 36, 38. STB 36, 28 may then request the responding STB act as a proxy for it. “Proxy”, as used herein generally refers to a processor being communicatively interposed between two applications, e.g., a STB and a service provider. The proxying STB may generally provide a back-channel communications path to the service provider. Thus, according to an aspect of the present invention, an STB coupled to a VDS may be used to interact with a service provider, e.g., order pay per view content in the case of a DBS VDS, even where it is not provided with its own back-channel connectivity, e.g., is not itself coupled to a PSTN.

Further, is may be desirable to integrate recorder functionality with one or more STBs to be co-located. According to an aspect of the present invention, one of the STBs to be co-located may be provided with recorder functionality that at least one other of the co-located STBs may access. In such a case, a digital video recorder (DVR) enabled STB may additionally be configured to store digital content. In such a case, an STB (FIG. 2) may additionally include a data storage device coupled via a data bus to the processor for storing program content data. It should be appreciated that a data storage device can be any memory or storage medium (e.g., included within memory 42, FIG. 2). Of course, an additional storage medium, such as a dedicated magnetic or optical disk and disk drive may be provided as part of memory 42 (FIG. 2). According to an aspect of the present invention, one or more co-located STBs being co-located with a DVR augmented STB may request access to the stored content by messaging the DVR augmented STB. Referring now again to FIG. 12, in such a case bandwidth portion 38 may be chosen to be sufficient to permit effective streaming of the stored content from the DVR augmented STB to the stored content requesting STB without interfering with other messaging. Optionally, messaging may be integrated with VDS messaging (e.g., FIG. 13), while data streaming is separate therefrom (e.g., FIG. 12)

It will be apparent to those skilled in the art that various modifications and variations may be made in the apparatus and process of the present invention without departing from the spirit or scope of the invention. Thus, it is intended that the present invention cover the modification and variations of this invention provided they come within the scope of the appended claims and their equivalents.

We claim:

1. A method for controlling a video processing unit adapted to receive and process program signals from a service provider, comprising the steps of:
establishing a communicative coupling with a second video processing unit, which is associated with a common subscriber account, via a local communications link; and
operating in one of first and second modes in response to received configuration information, wherein in the first mode the video processing unit periodically determines a co-location status with the second video processing unit and transmits authorization information via the local communications link to the second video processing unit in response to confirming the co-location status, and in the second mode processes the program signals to provide a display signal only upon receipt of authorization information via the local communications link.

2. The method of claim 1, further comprising the step of placing the video processing unit into a third mode from the second mode if the authorization information is not received within predetermined intervals of time, wherein in the third mode the video processing unit stops processing the received program signals.

3. The method of claim 2, further comprising the step of placing the video processing unit into a standby mode from the third mode only in response to a command received from the service provider.

4. The method of claim 3, wherein the video processing unit can be placed in one of the first and second modes only from the standby mode, the video processing unit receiving valid configuration information from one of a service installer, a user and the second video processing unit.

5. The method of claim 2, wherein the video processing unit is placed in the third mode from the first mode if the video processing unit is unable to establish communication with the second video processing unit within a predetermined period of time.

6. The method of claim 1, wherein in the first mode, the video processing unit discovers all other video processing units having co-location status and associated with the common subscriber account via the local communications link and transmits configuration information to the other video processing units to place the other video processing units in the second mode.

7. The method of claim 6, wherein the first mode, the video processing unit periodically determines the co-location status of each of the other video processing units and respectively transmits authorization information to each video processing unit for which co-location status is confirmed over the local communications link.

8. A video processing unit adapted to receive and process program signals from a service provider, comprising:
signal input for receiving the program signals from the service provider;
processing unit for processing the received content to provide a display signal;
communication unit for establishing communications with a second video processing unit over a local communications link; and
controller for placing the video processing unit in one of first and second modes in response to received configuration information, wherein in the first mode the video processing unit periodically determines a co-location status with the second video processing unit and transmits authorization information via the local communications link to the second video processing unit in response to confirming the co-location status, and in the second mode the processing unit processing the received program signals to provide a display signal only upon receipt of authorization information via the local communications link.

9. The video processing unit of claim 8, wherein the controller places the video processing unit into a third mode from the second mode if the authorization information is not received within predetermined intervals of time, wherein in the third mode the video processing unit stops processing the received content.

10. The video processing unit of claim 9, wherein the controller places the video processing unit into a standby mode from the third mode only in response to a command received from the service provider.

11. The video processing unit of claim 10, wherein the controller is able to place the video processing unit in one of the first and second modes only from the standby mode, and valid configuration information is received from one of a service installer, a user and the second video processing unit.

12. The video processing unit of claim 8, wherein in the first mode, the communication unit transmits co-location validation messages to all other video processing units coupled to the local communications link, and the controller transmits configuration information to all other video processing units having co-location status and associated with the common subscriber account via the local communications link to place the other video processing units in the second mode.

13. The video processing unit of claim 12, wherein the first mode, the controller periodically determines the co-location status of each of the other video processing units and respectively transmits authorization information to each video processing unit for which co-location status is confirmed over the local communications link.

14. A method for managing a plurality of video processing units associated with a common subscriber account, comprising:
configuring a first video processing unit of the plurality of video processing units to operate in a first mode;
configuring all other video processing units of the plurality of video processing units to operate in a second mode; and
establishing a communicative coupling between the plurality of video processing units via a local communications link, the first video processing unit periodically determining co-location status of the other video processing units and transmitting authorization information to the other video processing units in response to the co-location status being confirmed via the local communications link, the other video processing units processing received content from a service provider in response to receiving authorization information via the local communications link.

15. The method of claim 14, further comprising the step of placing selected ones of the video processing units into a third mode from the second mode if the authorization information is not received within predetermined intervals of time, wherein in the third mode the video processing unit stops processing the received content.

16. The method of claim 15, further comprising the step of placing the selected ones of the video processing units into a standby mode from the third mode only in response to a command received from the service provider.

17. The method of claim 16, wherein the selected ones of the video processing units can be placed in one of the first and second modes only from the standby mode, the video processing units receiving valid configuration information from one of a service installer, a user and the second video processing unit.
